(19) United States
(12) Patent Application Publication
(10) Pub. No.: US 2011/0215103 A1
(43) Pub. Date: Sep. 8, 2011

(54) THERMAL INSULATION CONTAINER HAVING A FOAM LAYER

(75) Inventor: Steven Lee, Tainan Hsien (TW)

(73) Assignee: PRESIDENT PACKAGING INDUSTRIAL CORP., Tainan Hsien (TW)

(21) Appl. No.: 12/845,975

(22) Filed: Jul. 29, 2010

(30) Foreign Application Priority Data
Mar. 3, 2010 (TW) 099203796

(51) Int. Cl. A47J 41/00

(52) U.S. Cl. 220/592.2

(57) ABSTRACT

A thermal insulation container includes a container body, an outer surrounding layer and a foam layer. The container body has a bottom wall and a surrounding wall extending upward from the bottom wall, and a receiving space confined by the bottom wall and the surrounding wall. The outer surrounding layer surrounds the surrounding wall of the container body. The foam layer is disposed between and bonded to an inner surface of the outer surrounding layer and the outer surface of the surrounding wall of the container body. The outer surrounding layer provides an even surface for a printed layer to improve the printed quality of the printed layer.

### CROSS-REFERENCE TO RELATED APPLICATION

This application claims priority to Taiwanese Application No. 99203796 filed on Mar. 3, 2010.

### BACKGROUND OF THE INVENTION

1. Field of the Invention

The invention relates to a thermal insulation container, more particularly to a thermal insulation container that is capable of insulating heat transferred from a hot drink contained therein.

2. Description of the Related Art

An ordinary paper-made or plastic disposable cup does not provide a thermal insulation effect. In order to prevent the user's hand from being burned while holding the disposable cup, a thermal insulation member is directly amalgamated to the outer surface of the cup body, or the cup is covered by a thermal insulation sleeve.

Referring to FIG. 1, a conventional thermal insulation cup 1 is shown to include a cup body 11 and a foam layer 12 covering and bonded to a surrounding wall 111 of the cup body 1. During manufacturing, before a foam layer 12 is foamed, it is first laminated over a substrate layer, and the resulting lamination is formed into a cup shape and heated to foam the foam layer 12. Since the foam layer 12 has a rough surface, when it is printed with a pattern, the pattern tends to be twisted, and hence is aesthetically distorted, or unrecognizable.

Referring to FIGS. 2 and 3, another conventional thermal insulation cup 2 is shown to include a cup body 21, and an outer surrounding layer 22 made of a non-foam material and adhering to a surrounding wall 211 of the cup body 2. The outer surrounding layer 22 includes a plurality of outer insulation portions 221 surrounding and spaced apart from the surrounding wall 211, and a plurality of inner coupling portions 222, each of which connects two adjacent outer insulation portions 221 and is concaved radially and inwardly. The aforementioned inner coupling portions 222 adhere to the surrounding wall 211, and enable the outer insulation portions 221 to be spaced apart from the surrounding wall 211 and to form insulation spaces 223.

Because the outer insulation portions 221 are connected to the inner coupling portions 222, heat generated by the hot drink can still be transmitted from the inner coupling portions 222 to the outer insulation portions 221, and then to the user's hand. Moreover, there is still a chance that the user's hand may touch the inner coupling portions 222, thereby allowing the user to be injured or feel uncomfortable. Furthermore, since the outer surrounding layer 22 is uneven, the pattern design over the outer surrounding layer 22 tends to be twisted, and hence may be aesthetically unappealing or distorted.

### SUMMARY OF THE INVENTION

An object of the present invention is to provide a thermal insulation container with improved thermal insulation effects and printing quality.

According to the present invention, a thermal insulation container comprises a container body, an outer surrounding layer and a foam layer. The container body has a bottom wall, a surrounding wall extending upward from the bottom wall, and a receiving space confined by the bottom wall and the surrounding wall of the container body. The outer surrounding layer is made of a non-foam material and surrounds an outer surface of the surrounding wall of the container body. The foam layer is disposed between and bonded to an inner surface of the outer surrounding layer and the outer surface of the surrounding wall of the container body.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional thermal insulation cup;

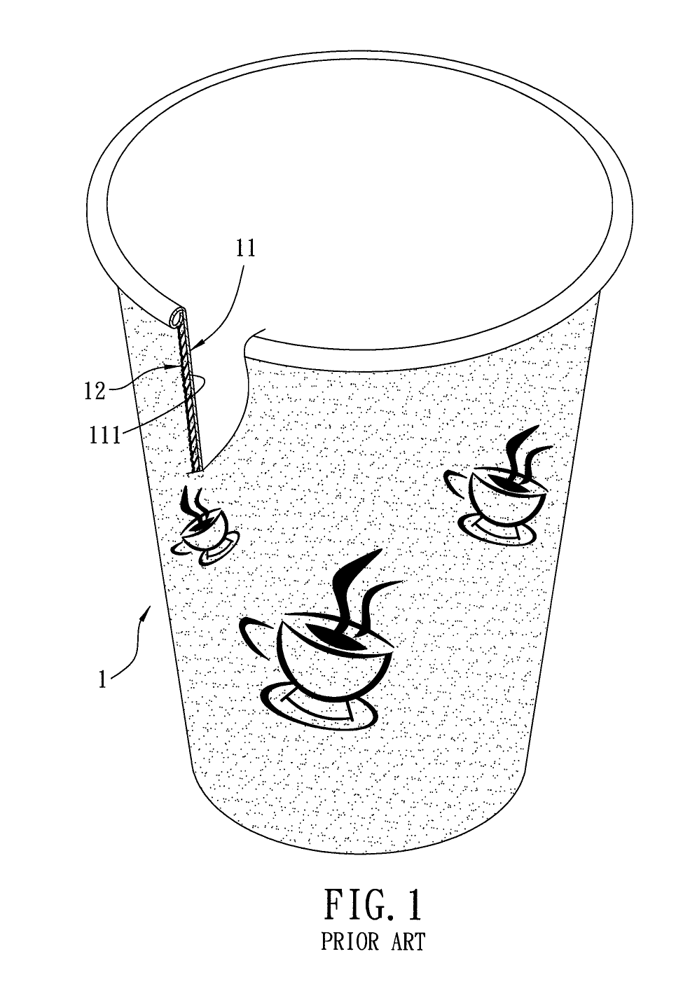

FIG. 2 is a perspective view of another conventional thermal insulation cup;

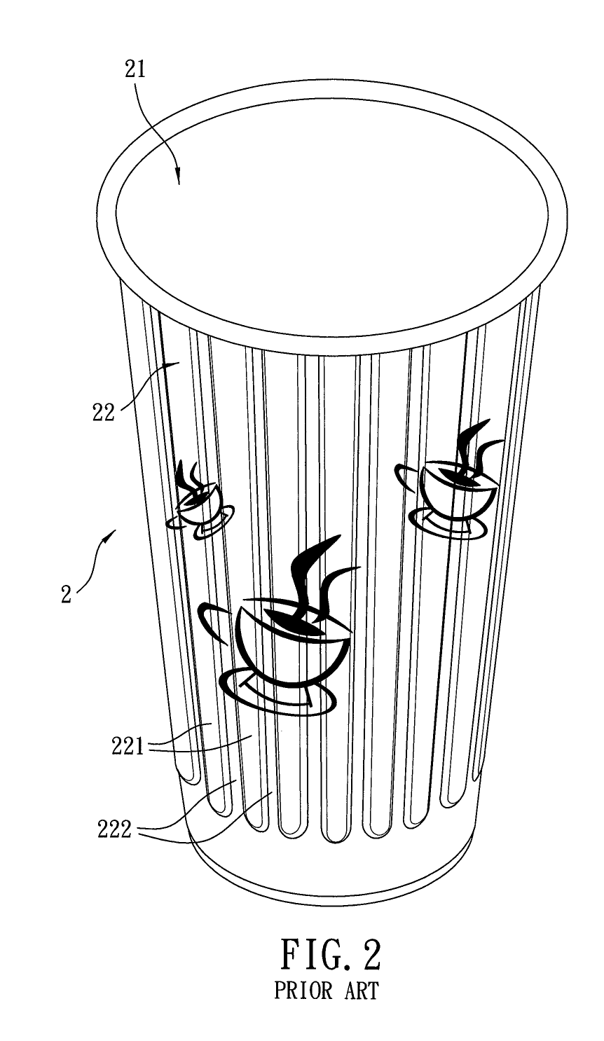

FIG. 3 is a fragmentary sectional view of the conventional thermal insulation cup of FIG. 2;

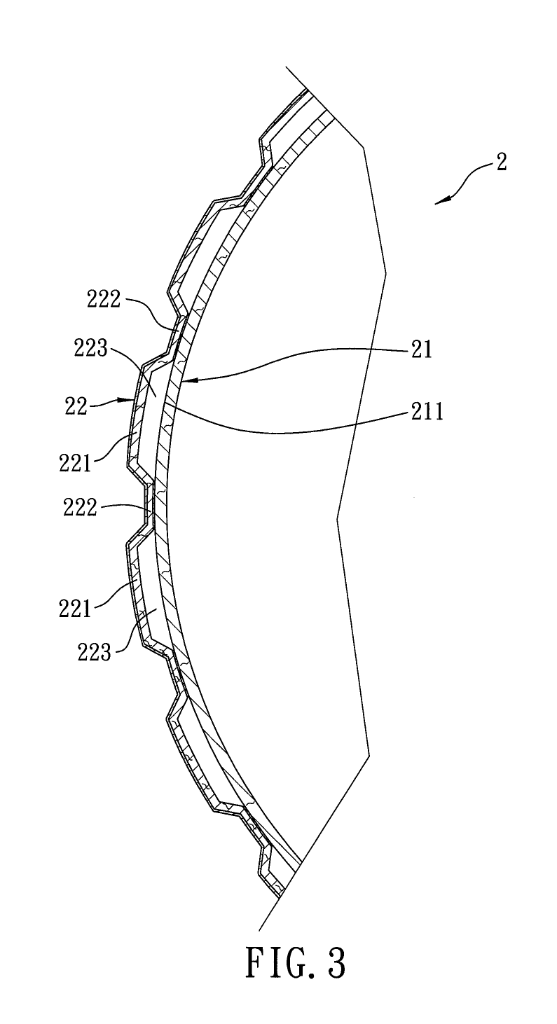

FIG. 4 is a perspective view of the first preferred embodiment of a thermal insulation container according to the present invention;

FIG. 5 is a fragmentary sectional view of the first preferred embodiment; and

FIG. 6 is a fragmentary sectional view of the second preferred embodiment of a thermal insulation container according to the present invention embodiment.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

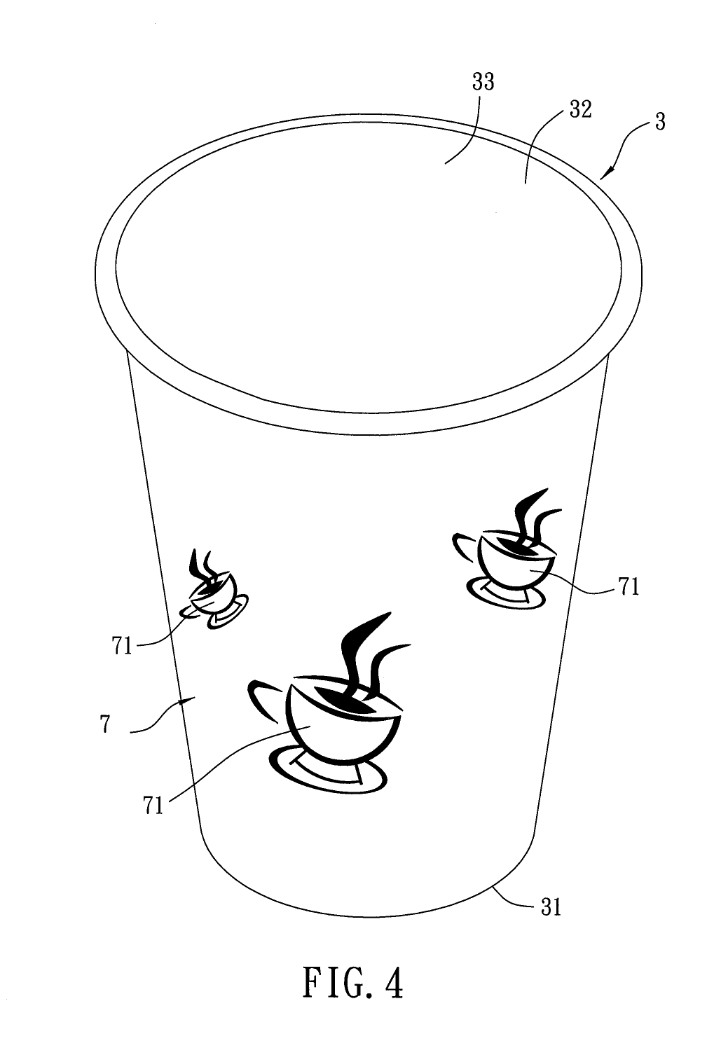

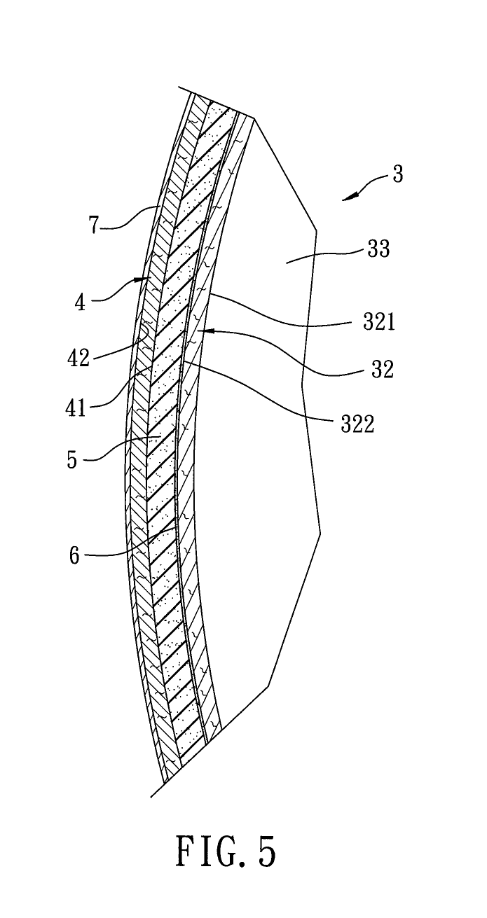

Referring to FIGS. 4 and 5, the first preferred embodiment of a thermal insulation container according to the present invention is configured as a thermal insulation cup. However, the present invention should not be limited to the disclosed embodiment, and may be embodied in other containers for containing a drink or soup, such as a bowl. In this embodiment, the thermal insulation container includes a cup-shaped container body 3, an outer surrounding layer 4, a foam layer 5, an adhesive layer 6, and a printed layer 7.

The container body 3 is made of paper or plastic, and includes a bottom wall 31 and a surrounding wall 32 extending upward from the bottom wall 31, and an upwardly opening receiving space 33 confined by the bottom wall 31 and the surrounding wall 32 for containing a drink. The surrounding wall 32 includes an inner surface 321 confining a receiving space 33, and an outer surface 322.

The outer surrounding layer 4 may be made of a non-foam material, such as paper, plastic, a film-laminated paper, or other composite sheet material. The outer surrounding layer 4 surrounds the outer surface 322 of the surrounding wall 32, and includes an inner surface 41 and an even outer surface 42.

The foam layer 5 is disposed between the surrounding wall 32 and the outer surrounding layer 4. Particularly, the foam layer 5 is bonded to the inner surface 41 of the outer surrounding layer 4 and to the outer surface 322 of the surrounding wall 32. The foam layer 5 is tubular. An outer surface of the foam layer 5 has the same surface area as the inner surface 41 of the outer surrounding layer 4, and an inner surface of the foam layer 5 has the same surface area as the outer surface 322 of the surrounding wall 32 of the container body 3. Accordingly, the foam layer 5 fills entirely a space between the surrounding wall 32 of the container body 3 and the outer surrounding layer 4. The foam layer 5 may be made of low density polyethylene (LDPE), high density polyethylene (HDPE), biodegradable polylactic acid (PLA), or other suitable material having thermal insulation properties. The foam layer 5 may be directly bonded to the outer surrounding layer 4 by applying a layer of foamable polymeric liquid directly onto the outer surrounding layer 4. The foamable polymeric liquid, after being cured, is formed into the foam layer 5 and is bonded to the outer surrounding layer 4 without using adhesive. Alternatively, the foam layer 5 may be bonded to the outer surrounding layer 4 through an adhesive so that an adhesive layer is formed between the foam layer 5 and the outer surrounding layer 4.

The adhesive layer 6 is disposed between the foam layer 5 and the outer surface 322 of the surrounding wall 32, and may include a double-sided adhesive tape, an adhesive film, or glue.

The printed layer 7 covers the outer surface 42 of the outer surrounding layer 4, and includes a plurality of pattern elements 71. A waterproof layer (not shown) may be applied to an outer surface of the print layer 7 to protect the printed layer 7.

For fabrication, the foam layer 5 may be foamed while being laminated on a sheet material to form the outer surrounding layer 4. The foam layer 5 may then be adhered, by means of the adhesive layer 6, to a sheet material to form the surrounding wall 32 of the container body 3. The resulting laminate is thereafter formed into a cup shape. Alternatively, the foam layer 5 and the outer surrounding layer 4 may be bonded to the container body 3 that has been preformed. The printed layer 7 may be bonded to the outer surrounding layer 4 before or after the container body 3 is formed.

When a hot drink is poured into the receiving space 33 of the container body 3, the foam layer 5 serves to insulate the container body 3 so that the heat is prevented from being transferred quickly to the user's hand. Because the outer surface 42 of the outer surrounding layer 4 is even, the printed layer 7 can be provided with clear pattern elements 71 with improved printing quality.

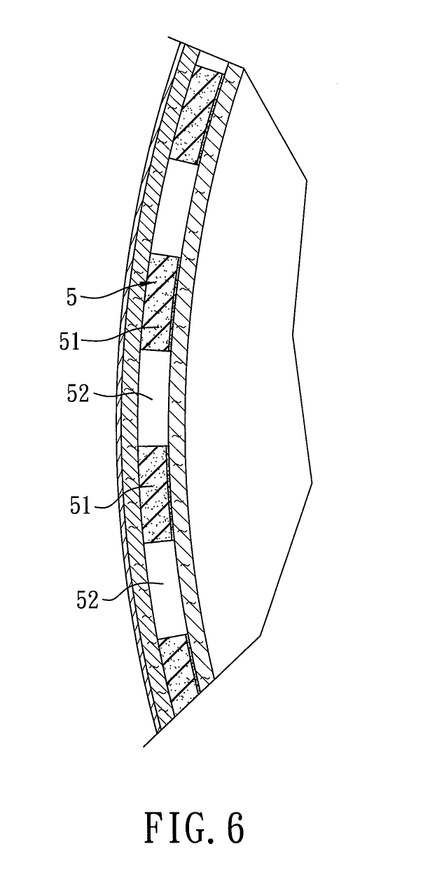

As shown in FIG. 6, the second preferred embodiment of this invention is shown to be generally identical to the first preferred embodiment in structure, and only differs from the first preferred embodiment in that the foam layer 5 includes a plurality of spaced apart foam portions 51, and a plurality of void portions 52 between the foam portions 51. Preferably, the foam portions 51 are separated from each other. Like the foam portions 51, the void portions 52 can provide a thermal insulating function. However, with the use of the void portions 52, the amount of material used for forming the foam layer 5 can be reduced, decreasing the cost of production. The void portions 52 may be configured to extend vertically or inclinedly from the bottom wall 31 of the container body 3, or to wind helically or annularly around the surrounding wall 32 of the container body 3. Any other regular or irregular design may be used to configure the void portions 52.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A thermal insulation container comprising:
a container body having a bottom wall and a surrounding wall extending upward from said bottom wall, and a receiving space confined by said bottom wall and said surrounding wall;
an outer surrounding layer made of a non-foam material and surrounding an outer surface of said surrounding wall of said container body; and
a foam layer disposed between and bonded to an inner surface of said outer surrounding layer and said outer surface of said surrounding wall of said container body.

2. The thermal insulation container of claim 1, further comprising an adhesive layer disposed between said foam layer and said outer surface of said surrounding wall of said container body.

3. The thermal insulation container of claim 1, further comprising an adhesive layer disposed between said foam layer and said inner surface of said outer surrounding layer.

4. The thermal insulation container of claim 1, wherein said foam layer fills entirely a space between said surrounding wall of said container body and said outer surrounding layer.

5. The thermal insulation container of claim 1, wherein said foam layer includes a plurality of spaced apart foam portions, and a plurality of void portions between said foam portions.

6. The thermal insulation container of claim 1, further comprising a printed layer covering an outer surface of said outer surrounding layer.

7. The thermal insulation container of claim 6, wherein said printed layer has a plurality of pattern elements.
